(19) United States
(12) Patent Application Publication
(10) Pub. No.: US 2017/0337509 A1
(43) Pub. Date: Nov. 23, 2017

(54) METHODS, SYSTEMS AND DEVICES FOR IMPROVED ORDER FULFILLMENT

(71) Applicant: 3VC ACTION APPS, LLC, Las Vegas, NV (US)

(72) Inventor: Miguel A. Veras-Nunez, Las Vegas, NV (US)

(21) Appl. No.: 15/603,277

(22) Filed: May 23, 2017

Related U.S. Application Data
(60) Provisional application No. 62/340,484, filed on May 23, 2016.

(51) Int. Cl. G06Q 10/08

(52) U.S. Cl. CPC G06Q 10/087

(57) ABSTRACT

Systems, methods and devices for network-connected order fulfillment using location based information for items included in the order to improve efficiency.

### CROSS REFERENCE TO RELATED APPLICATIONS

This application claims priority to U.S. Provisional Application No. 62/340,484, filed May 23, 2016, and titled “METHODS, SYSTEMS AND DEVICES FOR IMPROVED ORDER FULFILLMENT,” the entire contents and disclosures of which are hereby incorporated by reference.

### FIELD OF THE INVENTION

The field of the invention relates to order fulfillment.

### BACKGROUND OF THE INVENTION

Time and cost savings are integral in running a lean and efficient business and can lead to reduced overhead and increased profit. In various industries, order fulfillment can be a costly process. Human capital can be inefficient and prone to injury and sickness, leading to uncertainty. Lost or misplaced products can lead to wasted time and sunk economic costs in attempting to locate the products. Incorrect, incomplete or otherwise failed order fulfillment can lead to strained customer relationships, loss of goodwill, brand damage, lost costs in resolving issues, higher overhead for customer service and many other issues. Additionally, training for inexperienced workers, especially in industries with high attrition, rollover, or churn rates can waste resources for various entities.

There has been little advancement in attempting to streamline order fulfillment in most industries, and even less advancement in creating a solution that has wide applicability over many industries.

Therefore, it would be beneficial to create solutions that save entities time and monetary resources, improving productivity and easy adaptability for inexperienced workers.

### SUMMARY

Provided herein are embodiments of systems, methods, and devices for order processing and fulfillment using a mobile application. As described herein, once an order has been received it can be transmitted to a central location for processing, allowing an order fulfillment worker to gather items matching those requested in the order from inventory of the entity. In accordance with the features, concepts, and example embodiments described herein, completing an electronic order is more efficient than prior art solutions since it can mitigate human caused visual errors in identifying correct items to fulfill orders. Once an order has been scanned and received by a customer-facing employee or received directly at a central order processing location from a customer, the central location can compare the order with inventory information stored in an inventory database of that entity. If found, information regarding physical location of items included in the order which can be displayed on an order fulfillment worker's mobile device so that the items in the order can be gathered and presented to the customer in an efficient and accurate manner. As such, time savings for the entity is improved, error percentage for each order is reduced and cost savings for the entity is improved.

Through application of the principles and concepts described herein, an efficient accounting and monitoring of an order fulfillment transaction can be achieved with minimal or no human intervention in the process of gathering information from an inventory database or other reference location, allowing for multiple orders to be fulfilled in a more efficient fashion than single orders were processed in prior art systems. As such, these principles and concepts account for monitoring and comparing product details, including reading individual numbers of a product identification code in order to determine accuracy of order fulfillment, in ways that are more timely than normal human workers are currently able to accomplish.

Other implementations of the systems, methods, and devices described herein are contemplated as well. In various embodiments, the concepts and functionality described herein can be used to improve internal processing of various departments in many different entities, including, but not limited to: warehousing, courier services, storage facilities, restaurants, bars, clubs, hotels, and numerous others.

The configuration of these systems, methods, and devices is described in detail by way of various embodiments which are only examples.

Other systems, devices, methods, features and advantages of the subject matter described herein will be or will become apparent to one with skill in the art upon examination of the following figures and detailed description. It is intended that all such additional devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

Illustrated in the accompanying drawing(s) is at least one of the best mode embodiments of the present invention. In such drawing(s):

FIG. 1A is an example embodiment of a basic network setup diagram.

FIG. 1B is an example embodiment of a network connected server system diagram.

FIG. 1C is an example embodiment of a user mobile device diagram.

FIG. 2 is an example embodiment of a retail establishment order placing diagram.

FIG. 3 is an example embodiment of a retail establishment order fulfilling diagram.

FIG. 4A is an example embodiment of a customer order-inventory check flow diagram.

FIG. 4B is an example embodiment of a waiter order-fulfillment flow diagram.

FIG. 4C is an example embodiment of a delivery order-fulfillment flow diagram.

FIG. 5 is an example embodiment of a user interface sign-in screen.

FIG. 6 is an example embodiment of a user interface order management screen.

FIG. 7 is an example embodiment of a user interface new order information screen.

FIG. 8 is an example embodiment of a user interface order details screen.

FIG. 9 is an example embodiment of a user interface updated order details screen.

FIG. 10 is an example embodiment of an overview process diagram.

FIG. 11A is an example embodiment of a user interface login screen.

FIG. 11B is an example embodiment of a user interface store selection screen.

FIG. 11C is an example embodiment of a user interface store selection screen.

FIG. 11D is an example embodiment of a user interface item selection screen.

FIG. 11E is an example embodiment of a user interface Quick Appetite screen.

FIG. 11F is an example embodiment of a user interface WalletFILL checkout screen.

FIG. 11G is an example embodiment of a user interface order completion screen.

FIG. 11H is an example embodiment of a user interface order completion processing screen.

FIG. 11I is an example embodiment of a user interface order completion screen.

FIG. 12A is an example embodiment of a user interface login screen.

FIG. 12B is an example embodiment of a user interface virtual wallet sales menu screen.

FIG. 12C is an example embodiment of a user interface WalletFILL sales search screen.

FIG. 12D is an example embodiment of a user interface WalletFILL allocation screen.

FIG. 12E is an example embodiment of a user interface WalletFILL sales search information screen.

FIG. 12F is an example embodiment of a user interface WalletFILL Vault contents option screen.

FIG. 12G is an example embodiment screenshot of a user interface WalletFILL Vault screen.

### DETAILED DESCRIPTION

Before the present subject matter is described in detail, it is to be understood that this disclosure is not limited to the particular embodiments described, as such may vary. It is also to be understood that the terminology used herein is for the purpose of describing particular embodiments only, and is not intended to be limiting, since the scope of the present disclosure will be limited only by the appended claims.

Mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment and devices as appropriate to implement the methods and systems described herein are contemplated.

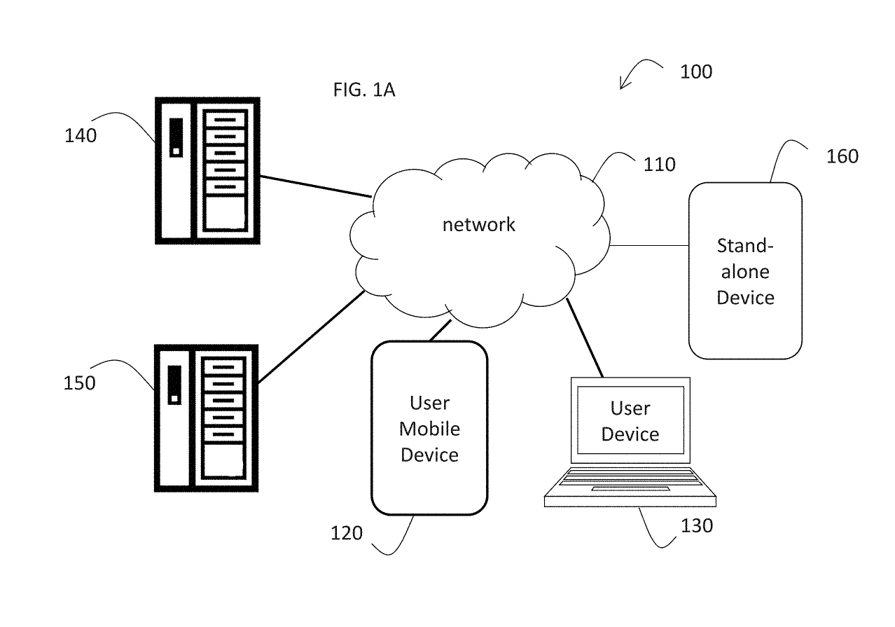

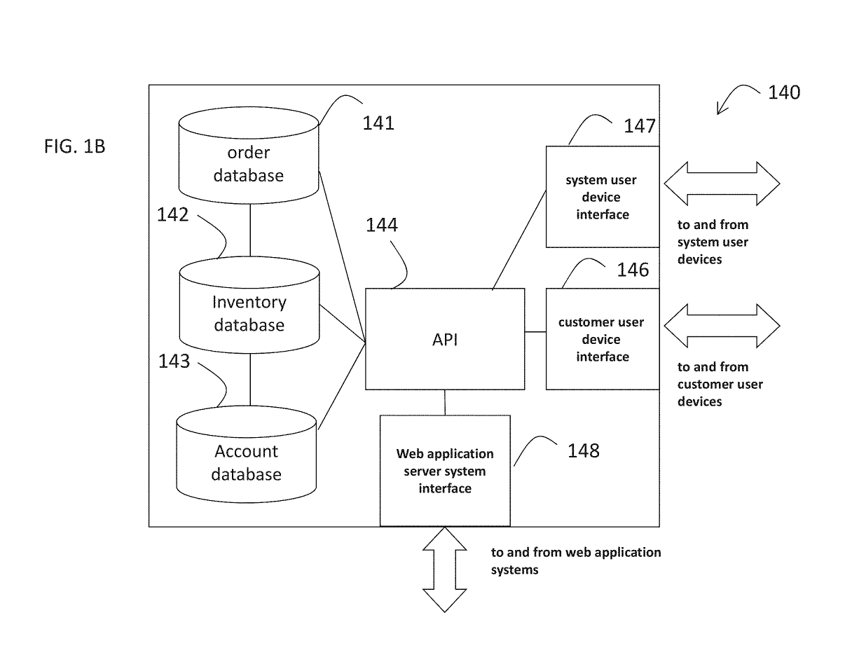

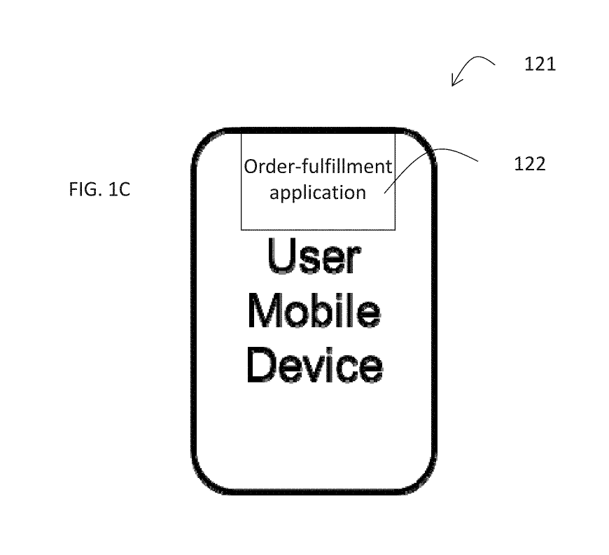

FIG. 1A is an example embodiment of a basic network setup diagram 100. As shown in the example embodiment, network setup diagram 100 of can include multiple servers 140, 150 which can include applications distributed on one or more physical servers, each having one or more processors, memory banks, operating systems, input/output interfaces, power supplies, network interfaces, and other components and modules implemented in hardware, software or combinations thereof as are known in the art. These servers can be communicatively coupled with a wired, wireless or combination network 110 such as a public network (e.g. the Internet, cellular-based wireless network or other public network), a private network or combinations thereof as are understood in the art. Servers 140, 150 can be operable to interface with websites, webpages, web applications, social media platforms, advertising platforms, and others. As shown, a plurality of end user devices 120, 130 can also be coupled to the network and can include, for example: user mobile devices such as smart phones, tablets, phablets, handheld video game consoles, media players, laptops; wearable devices such as smartwatches, smart bracelets, smart glasses or others; and other user devices such as desktop devices, fixed location computing devices, video game consoles or other devices with computing capability and network interfaces and operable to communicatively couple with network 110. Also shown is an example embodiment of a standalone device 160, operable to communicatively couple with network 110, which can be a device particular to an industry, entity, store, chain of stores, location, company or others, as appropriate, that is specifically purposed for use with particular products and includes all, some or no other functionality other than with particular systems and methods as described herein.

FIG. 1B is an example embodiment of a network connected server system diagram 140. As shown in the example embodiment, a server system can include at least one customer device interface 146 and at least one system user device interface 147 implemented with technology known in the art for facilitating communication between customer and system user devices respectively and the server and communicatively coupled with a server-based application program interface (API) 144. API 144 of the server system can also be communicatively coupled to at least one web application server system interface 148 for communication with web applications, websites, webpages, websites, social media platforms, and others. The API can also be communicatively coupled with a server based order database 141, account database 143, inventory database 142 combinations thereof or other databases and other interfaces. API 144 can instruct databases 141, 142, 143 to store (and retrieve from the database) information such as product information, user account information, associated account information, order information or others as appropriate. Databases 141, 142, 143 can be implemented with technology known in the art, such as relational databases, object oriented databases, combinations thereof or others. Databases 141, 142, 143 can be a distributed database and individual modules or types of data in the database can be separated virtually or physically in various embodiments.

FIG. 1C is an example embodiment of a user mobile device diagram 121. As shown in the example embodiment, a user mobile device, such as user mobile device 120 or standalone device 160 of FIG. 1A, can includes a network connected order-fulfillment application 122 that is installed in, pushed to, or downloaded to the user mobile device. In many embodiments user devices are touch screen devices such as smart phones, phablets or tablets which have at least one processor, network interface, camera, power source, memory, speaker, microphone, input/output interfaces, operating systems and other typical components and functionality.

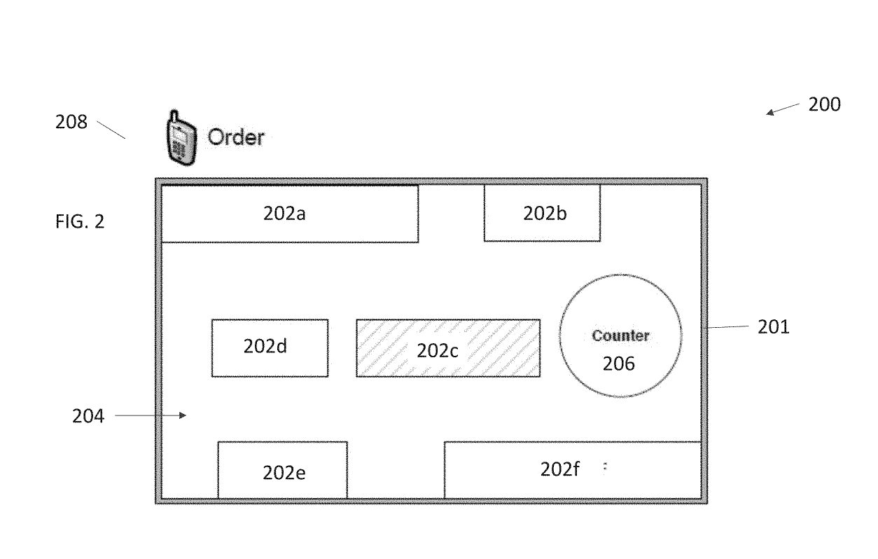

FIG. 2 is an example embodiment of a general retail establishment order placing diagram 200. As shown in the example embodiment, a retail establishment 201 can initially be divided according to the needs of the entity into individual sections, such as sections 202a, 202b, 202c, 202d, 202e, 202f and others, that can represent physical locations within an area of retail establishment 201, such as a warehouse (not shown), product floor 204 or others. Each section can have a particular number of items that are related, grouped or otherwise physically located within a certain proximity of each other. Also shown is a “Counter” 206, which can represent a processing area for each order. Thus, when an order is placed using a user device, user mobile device 208 or standalone device, the individual items required to fulfill the order can be easily found and retrieved based on their section for order processing at Counter 206. Also contemplated herein are sub-sections, sub-sub-sections, regions containing multiple sections and other groupings as desired or required based on the physical situation at a particular location or entity.

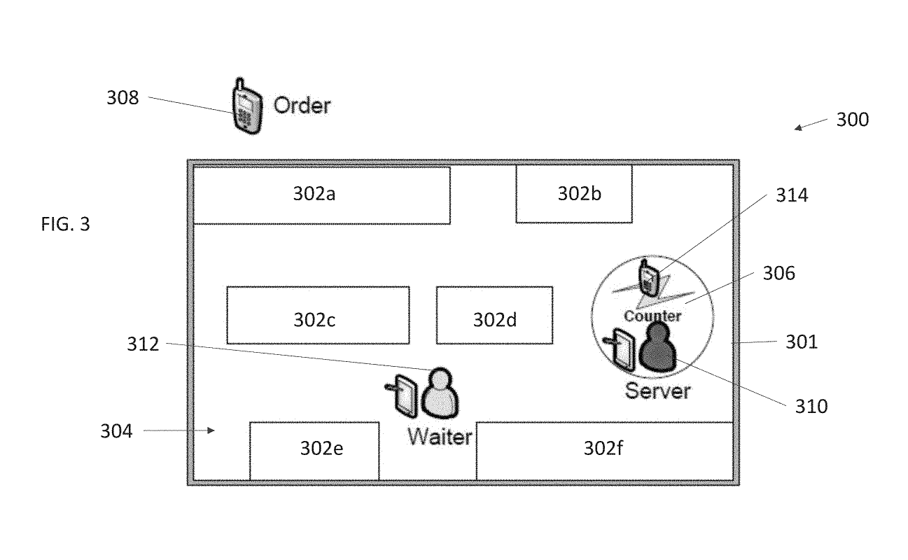

FIG. 3 is an example embodiment of a retail establishment order fulfilling diagram 300. In the example embodiment, a Server 310 and a Waiter 312 can work in complementary roles in order to fulfill an incoming order. An example of a basic process chain can include multiple steps such as: 1) an Order including one or more items can be received from a customer at an establishment 301 via a user device 308 and a Server 310 who is a user of a delivery reception device 314 at a Counter 306 and Waiter 312 can view the Order on their own user device, user mobile device, or standalone device; 2) Waiter 312 can retrieve items included in the Order from a product storage floor 304 in an efficient manner, based on item locations (e.g. sections 302a, 302b, 302c, 302d, 302e, 302f), to fill the Order; 3) Waiter 312 can deliver items individually, in groups or all at once to Server 310 at Counter 306; and 4) once all items have been received and grouped together, Server 310 can deliver the completed Order to the Customer. In some embodiments, Waiter 312 and Server 310 can be the same person, while in other embodiments it may be a different individual.

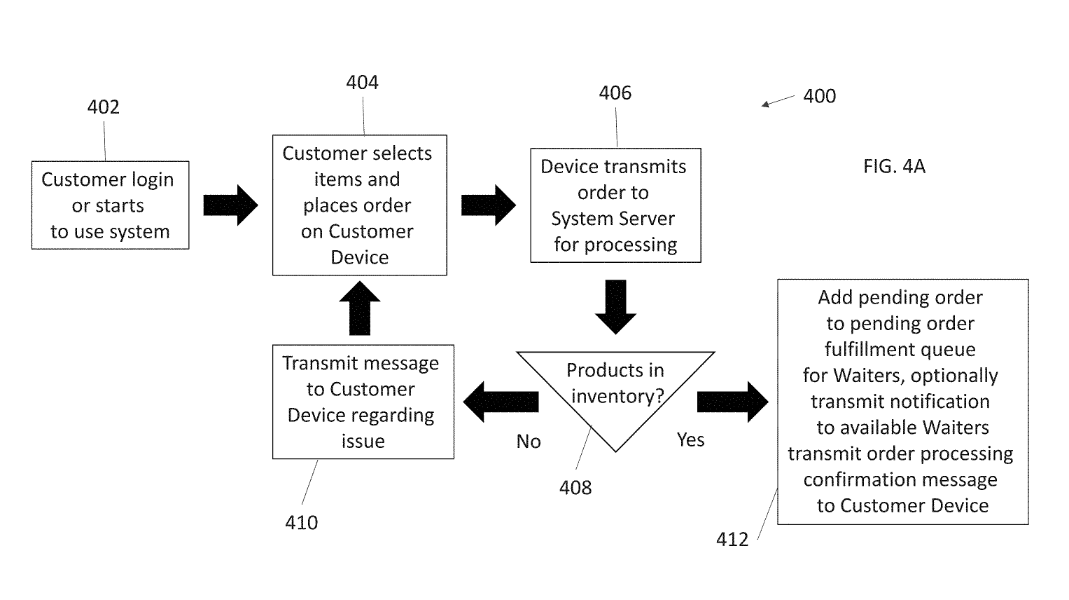

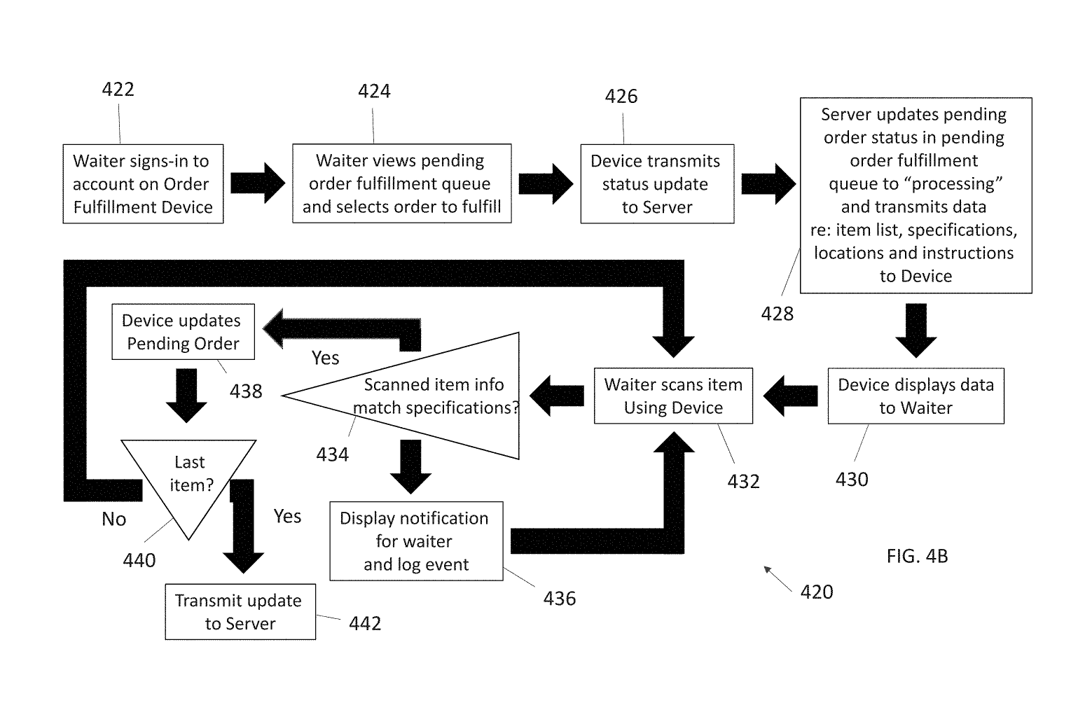

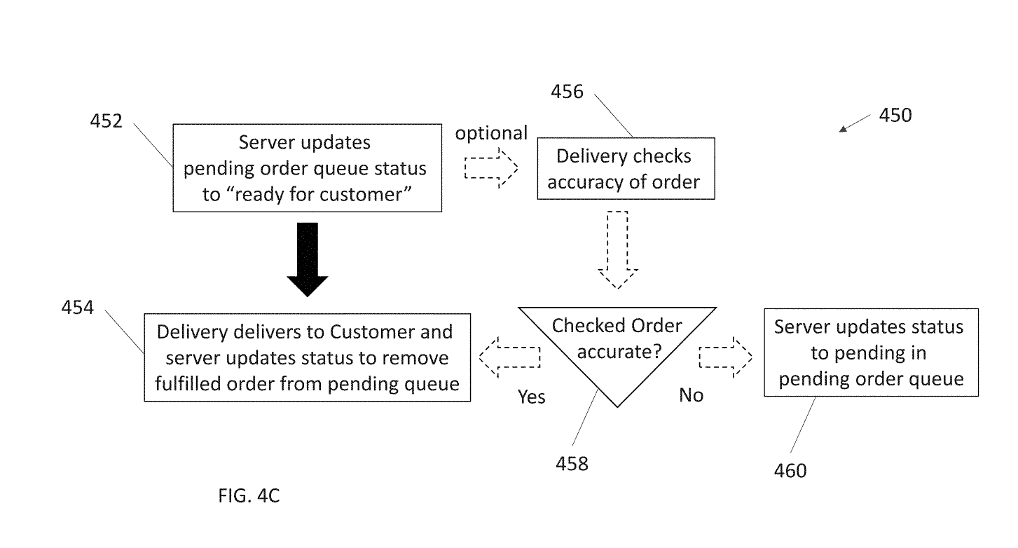

FIG. 4A is an example embodiment of a customer order-inventory check flow diagram 400. As shown in the example embodiment, a Customer can login or otherwise begin to use the system using a Customer Device in a first step 402. In some embodiments, the Customer Device is a standalone device that is located at the order fulfillment location. In some embodiments, users can place orders from remote locations using mobile or stationary devices via a network. Optionally, they may be able to request a time or location of fulfillment.

After logging in during step 402, the Customer can select items and place one or more orders using the Customer Device in step 404. The Customer Device can then transmit the order or order to a System server for processing in step 406. The system server can determine whether the items are located in inventory by checking each item against an inventory database in step 408. If not all items are in the inventory, the system server can transmit a message indicating this information along with which items are currently not in inventory, to the Customer Device in step 410. The Customer can then select different items if they wish to update their order or orders or cancel the order altogether. If all items in an order are in inventory in step 408, then the System server can add the order to an order database and update a pending order fulfillment queue for Waiters to fulfill, stored in non-transitory computer readable memory in step 412. The system server can also transmit an order processing confirmation message to the Customer Device. Optionally, it can send an update to available/online Order Fulfillment Devices for review by active Waiters in step 412.

FIG. 4B is an example embodiment of a waiter order-fulfillment flow diagram 420. As shown in the example embodiment, a Waiter can sign-in to a Waiter account on an Order Fulfillment Device (e.g. standalone device 160 of FIG. 1 or other system user mobile device) communicatively coupled to the System Server in step 422. The Waiter can then view a pending order fulfillment queue and selects an order to fulfill in step 424. The Order Fulfillment Device can transmit a status update to the System Server in step 426, which can then update the pending order status in the pending order fulfillment queue to “processing” and transmit data regarding an item list, specifications for the items, locations of the items, and instructions for how to retrieve the items to the Order Fulfillment Device in step 428. The Order Fulfillment Device can selectively display this information to the Waiter in step 430 who can then retrieve each item in the order. Once the Waiter has arrived at an indicated location for an item in the order, the Waiter can scan a UPC code, Barcode, QR code, product name, custom code or other product indicating information using a camera, scanner or other image capturing component of the Order Fulfillment Device in step 432. The device can perform image processing and compare scanned image information with the specification information received from the system server in step 434. If the scanned image information does not match the specification information in step 434, the Order Fulfillment Device can display an error message and log the event in non-transitory computer readable memory in step 436. The Waiter can then scan additional items in step 432. If the information does match an item in the Order Fulfillment Device can update information regarding the pending order in step 438 and check as to whether the item is the last item required to fully fulfill the order in step 440. If it is not, then the waiter can scan additional items using the device in step 432. However, if it is, then the Order Fulfillment Device can transmit an update to the system server and the Waiter can bring the items to the Counter in step 442.

FIG. 4C is an example embodiment of a delivery order-fulfillment flow diagram 450. As shown in the example embodiment, once a Server receives notification from an Order Fulfillment Device that all items have been located and retrieved for an order, it can update the pending order queue status to “ready for customer” in step 452 and a Delivery employee or automated employee can deliver the order to a Customer upon the Customer's arrival or at another location in step 454. The system server can update the status to remove the fulfilled and delivered order from the pending queue and log the successful order fulfillment in step 454.

Optionally, once the Delivery employee or automated employee receives all items in an order in step 452, the system can automatically or selectively check the accuracy of the order in step 456. If the checked order is accurate in step 458, it can be delivered to the Customer as described above in step 454. If the checked order is not accurate in step 458, then the system server can be updated to reflect this information and the status of the order can be updated to pending and the order can be reintroduced or updated in the pending order queue in step 460.

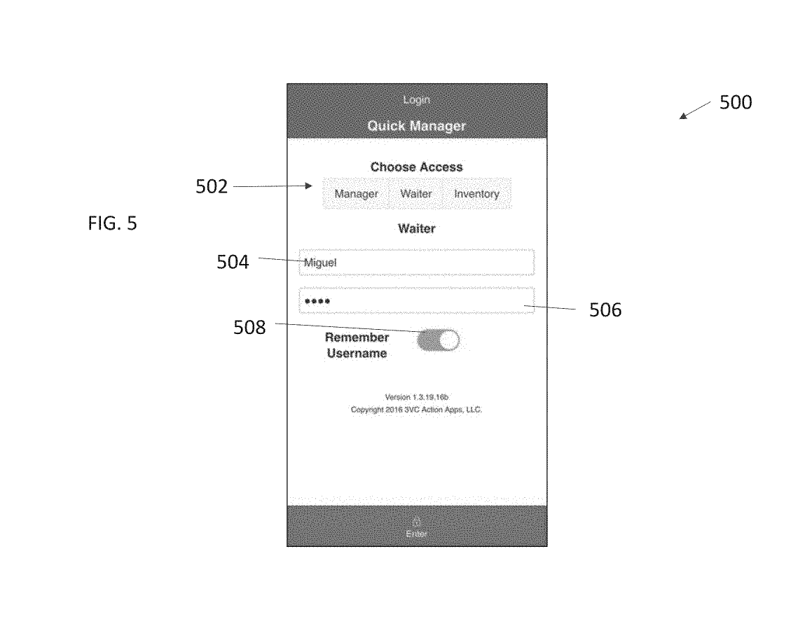

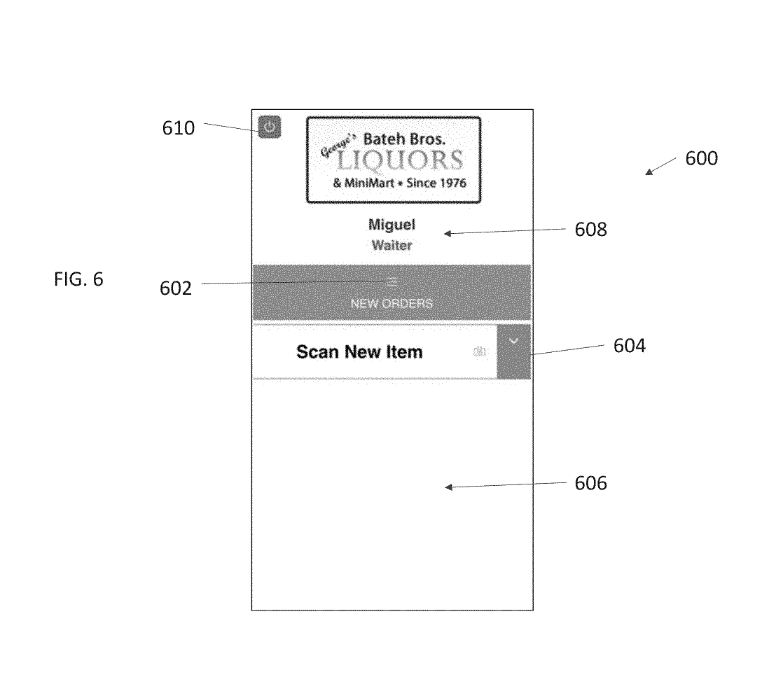

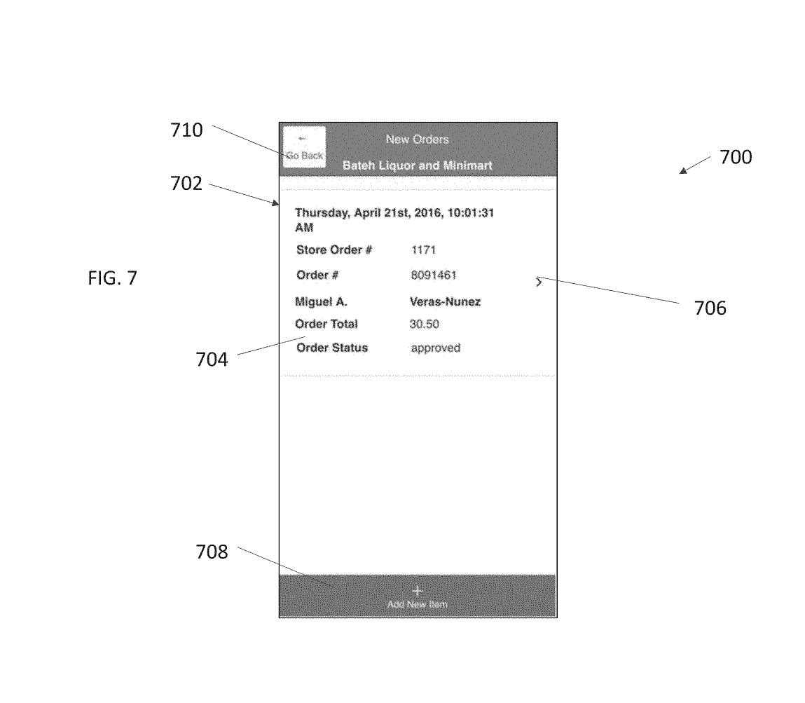

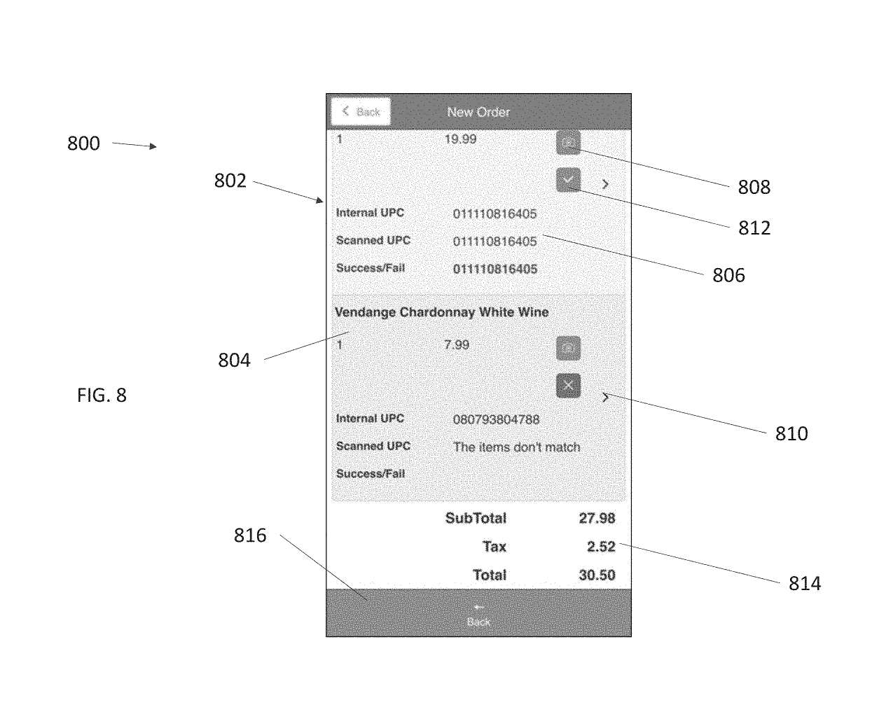

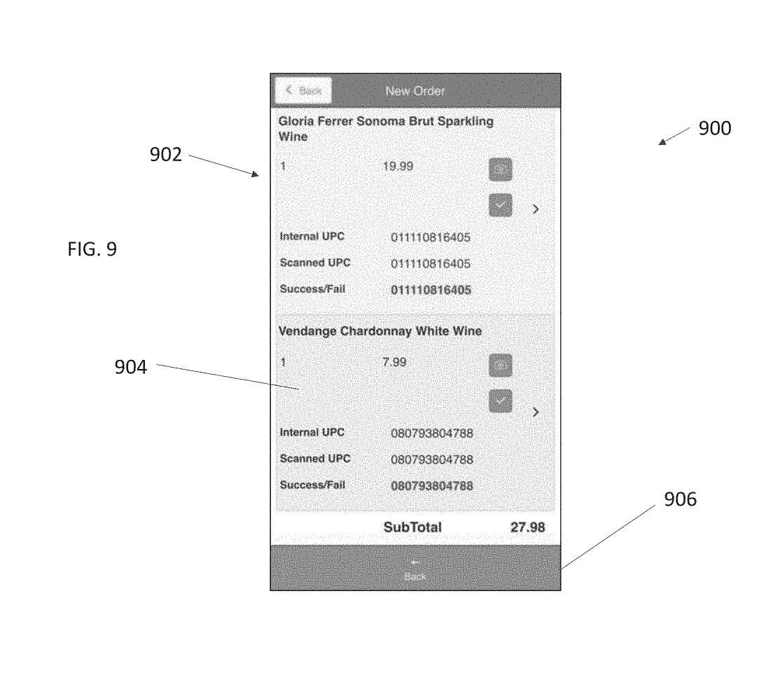

FIGS. 5-9 show user interface screens corresponding to an example embodiment implementation of the systems, methods and devices described herein. As such, FIG. 5 represents an example embodiment user interface screen 500 of a Waiter sign-in, FIG. 6 represents an example embodiment user interface screen 600 of a Waiter selecting orders, FIG. 7 represents an example embodiment user interface screen 700 of a Waiter choosing a most recent, or any other unprocessed order, FIG. 8 represents an example embodiment user interface screen 800 of a Waiter searching for and scanning items to complete the order and FIG. 9 represents an example embodiment user interface screen 900 of a Waiter having matched all items in an order and proceeding to complete the order. Each of these will be described in more detail below.

FIG. 5 is an example embodiment of a user interface sign-in screen 500. As shown in the example embodiment, an administrative-side system user can log into the system by selecting a profile type such as “Manager,” “Waiter,” “Inventory,” or others by selecting the type from profile buttons 502. The user can then enter a username in username field 504, a password in password field 506, and choose whether to have the device remember the username entered in username field 504 by selecting either yes or no using button or slider 508.

FIG. 6 is an example embodiment of a user interface order management screen 600. As shown in the example embodiment, if a Waiter user is authorized and authenticated on an Order Fulfillment Device, the user interface can display a “New Orders” drop down list menu of pending orders for fulfillment by selecting a list menu button 602. Additionally, the Waiter user can choose options related to using the device to scan items for order fulfillment by selecting a “Scan New Item” button 604 for dropdowns. Then the user can aim a device camera or other scanner coupled with the Order Fulfillment Device at a product or portion of a product packaging and capture an image or scan a barcode. This can be displayed in a camera display area 606. The current user profile logged in can displayed in username field 608 and the user can turn the device off by selecting on/off button 610.

FIG. 7 is an example embodiment of a user interface new order information screen 700. As shown in the example embodiment, order information for a particular order can be displayed in a list 702. In the example embodiment, there is only one order in list 702. The user can view an order information overview in an order information overview field 704 that can include a date and time an order has been placed, a store order number, a system order number, an employee name or other employee indicator, a total price of an order, and an order status. Other information can also be included, as appropriate, including quantity, time expected to fulfillment, time since fulfillment has begun and various others. In some embodiments, this information can be displayed after selecting an additional order information button 706. Many of these types of information can be stored in an order fulfillment database for review, analysis, and others, that can be automatic, manual or a combination thereof. As shown, users can also add new items to orders or to the list of orders using button 708. A back button 710 can take a user back to a previous screen if selected.

FIG. 8 is an example embodiment of a user interface order details screen 800. As shown in the example embodiment, a new order information screen can include a list of items 802, each with information about their individual prices, quantities, associated internal UPC numbers and others in item information field 804. Once a Waiter has scanned an item, it has undergone image processing, and it has been checked for accuracy against a database or been through another accuracy defining information check process, a scanned UPC can be shown and also an indication of whether the scanned UPC matches the internal UPC in a scanned item field 806. As shown, Waiters can view images of each item by selecting an image display button 808 and can also view additional information by selecting a more detailed product information viewing button 810. Matching indicator field 812 can show a Waiter whether they have successfully scanned the item. Additional order information displayed in an additional order information field 814 can include an order subtotal, tax, and order grand total. A back button 816 can allow a user to navigate to a previous screen in the application.

FIG. 9 is an example embodiment of a user interface updated order details screen 900. As shown in the example embodiment, a successfully scanned order list 902 can show product information for all scanned items matching their internal information in field 904. A back button 906 can allow a user to navigate to a previous screen in the application.

As described herein, “FastFlow” can be considered an example embodiment of an overall system or program. A “Quick Market Manager” can be a program or system that manages results, including results from a “WalletFILL” system or program. Quick Market Manager can be considered an example embodiment process that is executed through a user mobile device application. A “Quick Appetite” program or system can be considered an example embodiment of a user mobile device application. Quick Appetite can be used by a customer to purchase one or more items in a retail establishment, such as a supermarket. Once a successful transaction has occurred, the WalletFILL process can be performed, which, in an example embodiment, performs functions that calculate one or more distributions to one or more WalletFILL Benefactors.

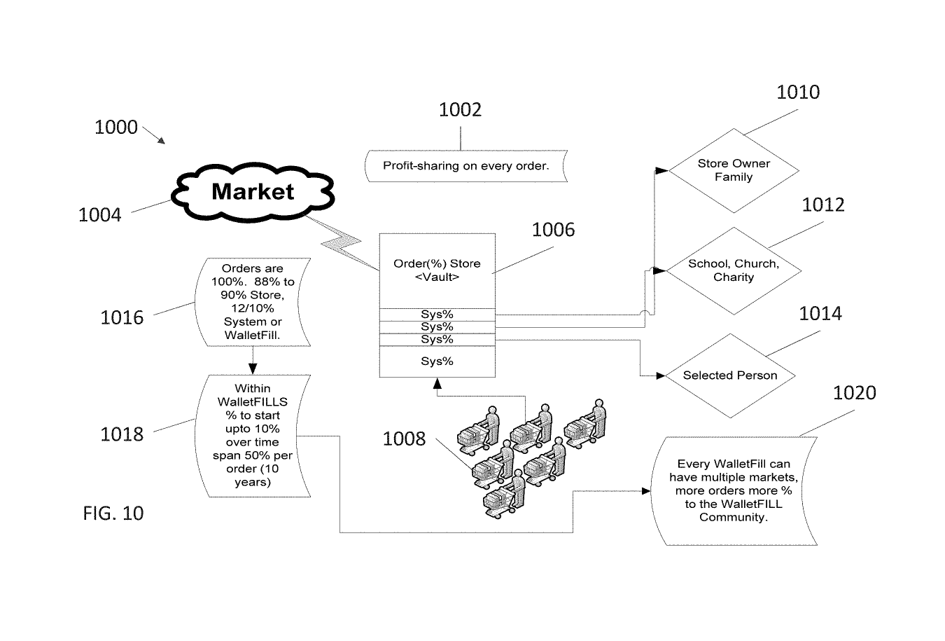

FIGS. 10, 11A-11I, and 12A-12G show an example embodiment of how an order can be processed in an example embodiment. These include the use of a FastFlow system with new item scanning and a conventional processing system with item selection. Once an order is completed, it can be paid for using a digital wallet application that processes and distributes the proceeds of the transaction to the seller. The FastFlow system will be referred to herein with respect to a Quick Appetite application.

Also described is a WalletFILL can partner with likeminded businesses to create new purchasing options for products in the marketplace and facilitate accelerated transaction processing. One advantage that WalletFILL provides is that it can serve as a periodic funding mechanism that provides funding on a recurring basis, such as instantaneous, hourly, daily, weekly, monthly, or another periodic basis. As such, funding can be provided outside of currently available channels for entities that may have difficulty finding funding from the public or other institutions. Examples of various entities that can be positively benefited include schools, churches, charities, startup companies, and many others and are referred to herein as Benefactors. By partnering system operators, existing companies, and Benefactors, development and growth of new technologies, products, and services can occur in instances where they may not otherwise flourish.

Quick Appetite and Quick Market Manager can be two applications that are used to facilitate management of a WalletFILL process. Quick Appetite can be a “do-it-yourself” application that is largely customizable. It can be accessed using an account created in systems using a Quick Market Manager application. These two applications can allow supermarkets, retail stores, restaurants, and other establishments to add their products in a searchable database for users via online computer networks and process transactions through purchasing processes.

In various embodiments, Quick Appetite applications and Quick Market Manager with WalletFILL applications can be protected by encryption, or other methods, including SSL protection. Additionally, all orders can be SSL protected.

FIG. 10 is an example embodiment of an overview process diagram 1000. As shown in the example embodiment, a feature 1002 of systems and methods described herein allows profit sharing functionality for one, some, selected, many, or all order transactions. A market 1004 can transmit an order, via a wireless, wired, or combination communication network to a Store Vault 1006, which can be a computer server. Likewise, transactions from customers 1008 can also be transmitted to Store Vault 1006. Store Vault 1006 can store these transactions and orders in non-transitory computer readable memory and also perform processing on them using preset rules and instructions. As such, system percentages can be calculated by Store Vault 1006 that are donated or otherwise granted to one or more Benefactors. Benefactors can be set according to administrative policy and can include store owner families 1010; schools, churches, charities 1012; selected people 1014; or others, as appropriate.

As also shown in the example embodiment, another feature 1016 allows for order percentages to be variable and modifiable in some embodiments. For example, feature 1016 allows orders to be set at 88% kept by the store and 12% kept by the system or WalletFILL, 90% kept by the store and 10% kept by the system or WalletFILL, or many other combinations.

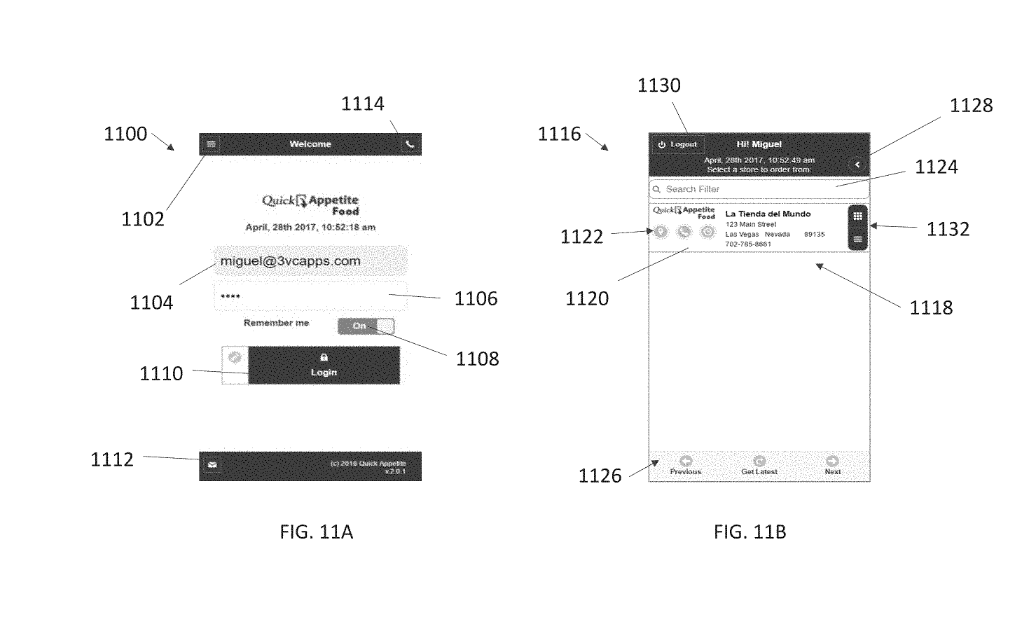

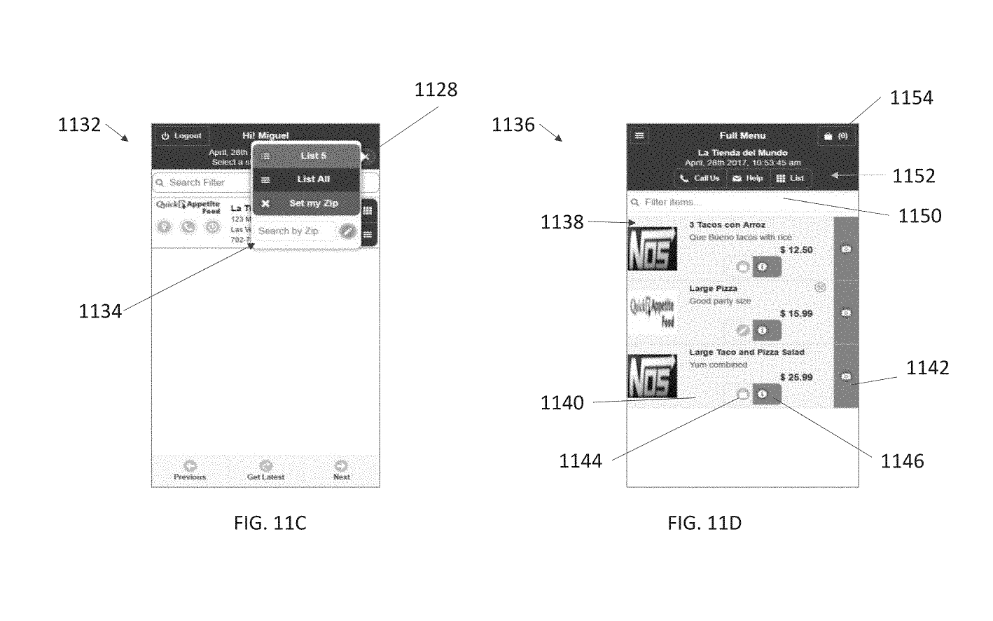

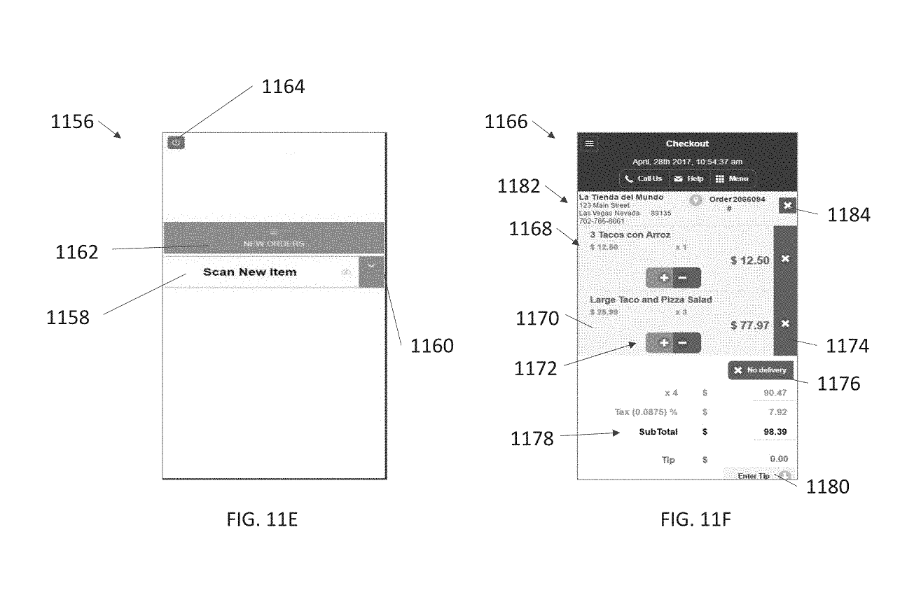

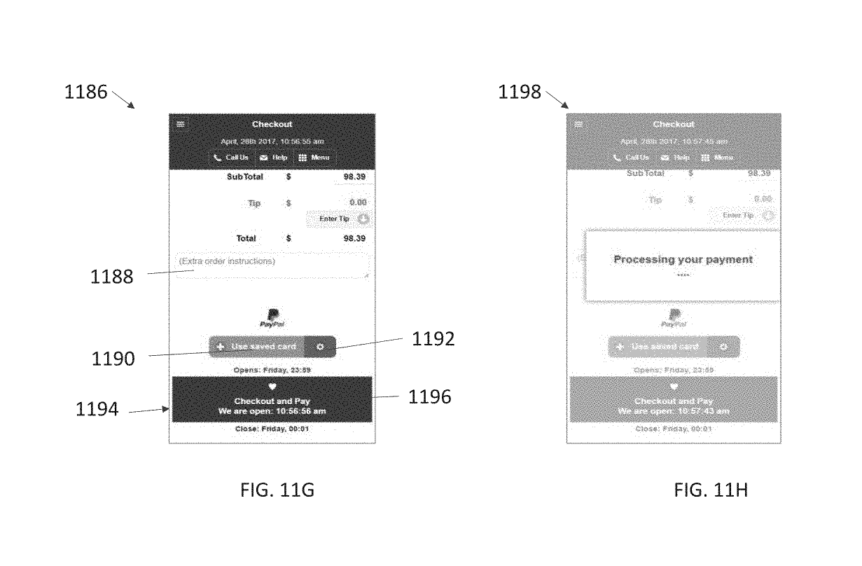

FIG. 11A is an example embodiment of a user interface login screen 1100. As shown in the example embodiment, a user can select a menu button 1102 to access an options menu for application navigation and information. The user can also enter a username in username field 1104, a password in password field 1106, and choose whether to have the device remember the username entered in username field 1104 by selecting either yes or no using button or slider 1108 before submitting the request by selecting a login button. A mail button 1112 can display email for an account and a phone button 1114 can allow users to call or contact a store for help.

FIG. 11B is an example embodiment of a user interface store selection screen 1116. As shown in the example embodiment, once logged in, a user can view a list 1118 of stores that show store information 1120 before selecting a store to shop at. Store information 1120 can include a store name, address, phone number, website, email, or others, as appropriate. Users can also select buttons 1122 to view the store location on a map, call the store, and view store hours. Users can also search for stores by entering information in a search field 1124. Navigation buttons 1126 can allow the user to return to previous screen listing screens, refresh information, move to a next listing screen, or perform other actions. An edit button 1128 can allow users to change information displayed, based on their preference. A logout button 1130 can log the user out of the current user account. One or more list type buttons 1132 can change the type of listing and information displayed. For example, they can change to gallery, list with information, list with image or other modes.

FIG. 11C is an example embodiment of a user interface store selection screen 1134. As shown in the example embodiment, edit button 1128 has been selected and a popup window 1134 with additional buttons and fields has been displayed, including changing the displayed store list to a preset number, here “5”; showing all stores in the list; setting or removing a zip code; and searching by zip code in a zip code field.

FIG. 11D is an example embodiment of a user interface item selection screen 1136. As shown in the example embodiment, once logged in, a user can view a list 1138 of stores that show item information 1140 that can include an image of a label or the product, a description, price information and others. Users can select an image button 1142 to view additional images of the item. Users can select an additional item information button 1146 to view more information about the item. Users can select an add to cart button 1144 to add the item to a current order. A filter field 1150 allows users to enter terms to filter items currently displayed in the listing. Users can select buttons 1152 to make a telephone call to the store, view help topics, and change listing styles. A cart button 1154 to view the store location on a map, call the store, and view store hours.

FIG. 11E is an example embodiment of a user interface WalletFILL screen 1156. As shown in the example embodiment, a user can select a scan new item button 1158 to scan items to add to a current order. In some embodiments, this can include bringing up a camera display. An options button 1160 allows users to view and select different scanning types. A new orders button 1162 allows users to view newly received orders. An off button 1164 turns the application off.

In an example embodiment, when a system user views screen 1156, the display can indicate the ability of the user to locate a product within the system. As such, if the user is shopping in a retail establishment and locates a desired item, such as a bottle of shampoo, they can scan the item using button 1158. Where the system is functionally applied with numerous different participating retail entities, it can then search through one or more of the retail entities item databases and return a listing of the store or stores that carry the product, as well as other information.

In some embodiments, this can also tie into a single entity order fulfillment process. As such, an item scan using button 1158 will search the item database for the order fulfilling store, as applied to the order fulfillment process for that particular entity. At an entity level for a particular retail establishment, waiters and servers may be able to participate with a WalletFILL associated payment program internally, by generating tips, residual income, and other income on a per order basis. As such, WalletFILL can provide them an enhanced incentive to fulfill orders swiftly and effectively, since accuracy and time can be factored into the program guidelines.

FIG. 11F is an example embodiment of a user interface Quick Appetite checkout screen 1166. As shown in the example embodiment, users can view a list 1168 of all items selected and added to the current order. Each item listing 1170 can include a description of the item, a price per item and quantity ordered and total price for the quantity of item selected. Users can modify orders by adjusting quantity of items using quantity buttons 1172 or remove items completely using remove button 1174. Users can select whether to have items delivered using a delivery button 1176. An order overview information field 1178 can display a total quantity of items, a tax percentage and calculation, a subtotal, a tip amount, and a grand total. Users can enter a tip by selecting an enter tip button 1180 or entering an amount in an appropriate field. Store information 1182 can display a name, location, and contact information for the store, as well as an order number. Order cancellation button 1184 allows users to delete orders.

FIG. 11G is an example embodiment of a user interface order completion screen 1186. This screen can be separate from checkout screen 1166 or can be part of the same screen after scrolling down. As shown in the example embodiment, users can enter additional order instructions in field 1188. Users can select a use saved card button 1190 to view a list of saved cards. A settings button 1192 allows users to view and modify current payment settings. Additional store information 1194 can describe store hours, and allow users to checkout and pay with an order completion button 1196.

FIG. 11H is an example embodiment of a user interface order completion processing screen 1198. As shown, once an order completion button 1196 has been selected, the system can display an icon indicating that the order is being processed.

FIG. 11I is an example embodiment of a user interface order completion screen 1199. As shown, all details of the order can be displayed, including store information, type and quantity of items, total price, credit card details, and others. Users can also select buttons 1197 allowing them to return to a menu and continue using the application, call the store, and view help topics. Order completion screen 1199 can include an option to email, text, call, or otherwise perform secondary verification of the order.

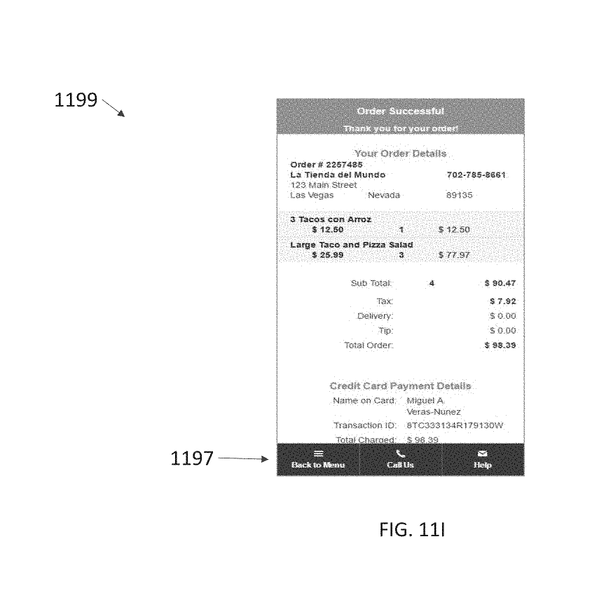

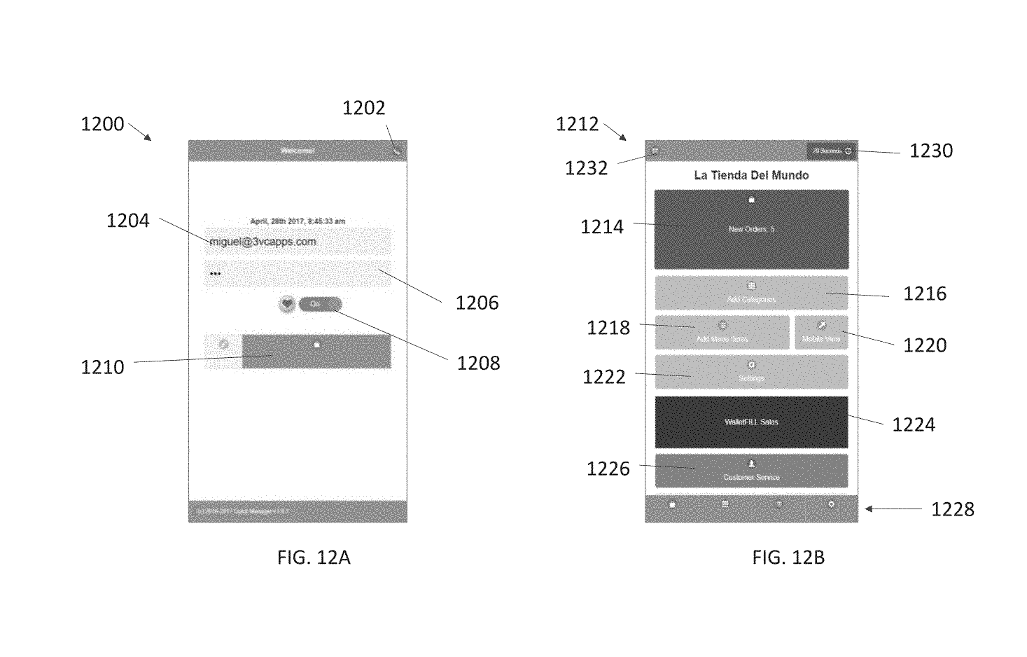

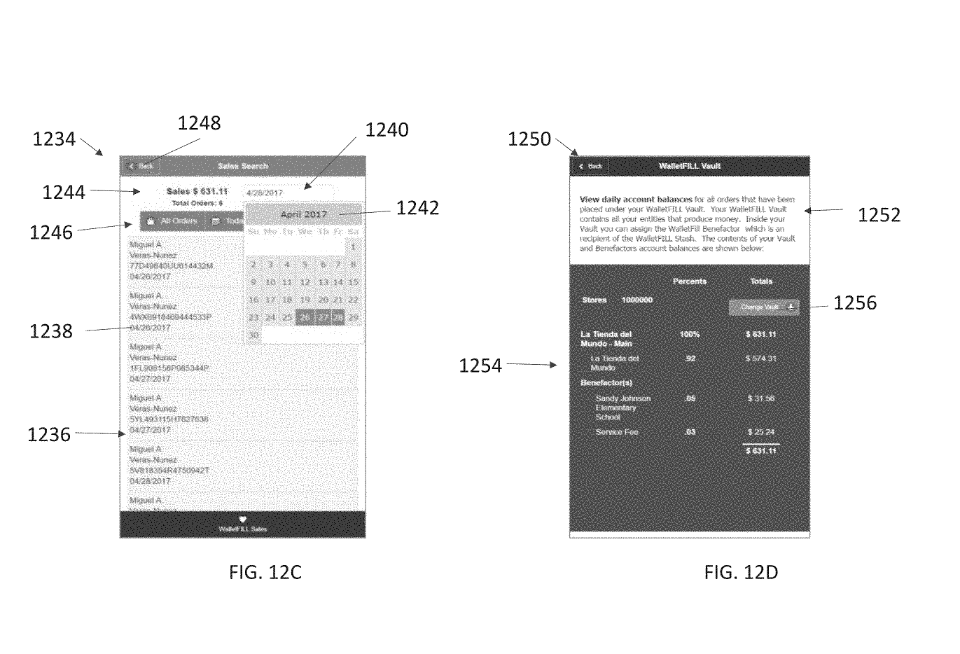

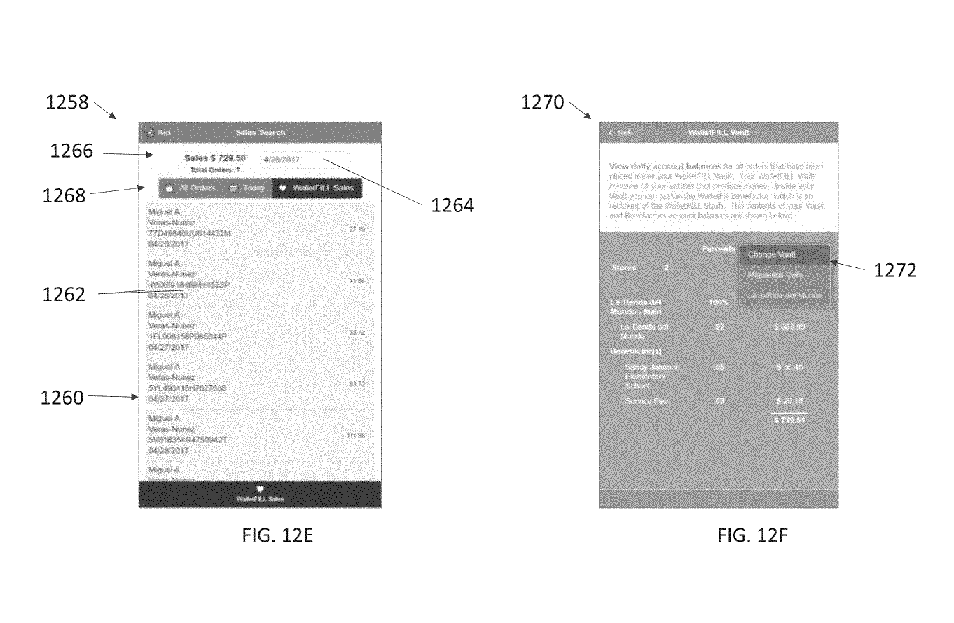

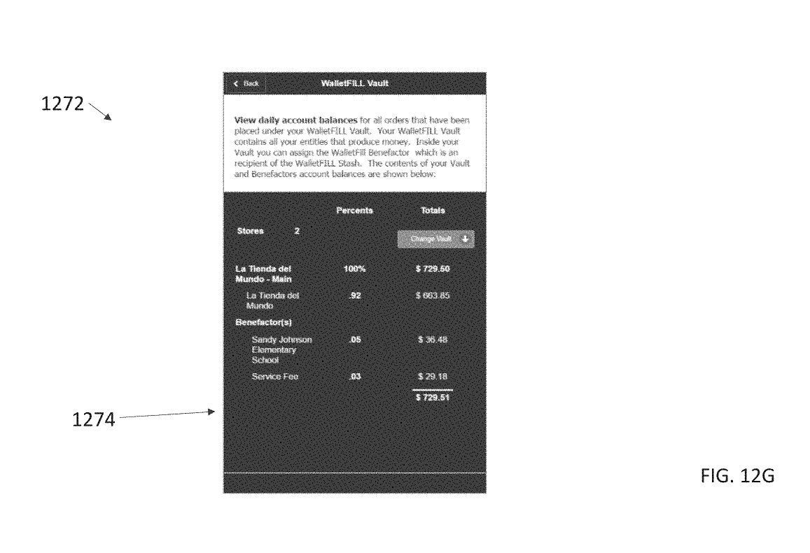

FIGS. 12A-12G show an example embodiment of how an order can be processed in an example embodiment. As such, they show the process of a store receiving an order on a Quick Market Manager application and its various steps before payment processing at the WalletFILL in FIG. 11E described previously. The Quick Market Manager allows received orders to be accumulated and then the proceeds can be distributed according to percentages assigned to the system, Benefactors, and store, as described with respect to FIG. 10. As such, the system can complete fund transfers to Benefactors via electronic payment, such as PayPal or other potential payment processing systems.

FIG. 12A is an example embodiment of a user interface login screen 1200. As shown in the example embodiment, a user can select a phone button 1202 to can allow users to call a store for help. The user can also enter a username in username field 1204, a password in password field 1206, and choose whether to have the device remember the username entered in username field 1204 by selecting either yes or no using button or slider 1208 before submitting the request by selecting a login button 1210.

FIG. 12B is an example embodiment of a control center main or home screen used to create, update, and otherwise manage a store listed in Quick Appetite 1212. Once a user has logged into the system, they can view various options in menu screen 1212. As shown in the example embodiment, a new orders button 1214 can display all new orders received. An add categories button 1216 allows users to add or modify categories of items. An add menu items button 1218 allows users to add or modify menu items. A mobile view button 1220 shows a mobile interface view. A settings button 1222 allows users to modify settings. A WalletFILL Sales button 1224 allows users to view all current WalletFILL sales information. Selecting a customer service button 1226 will display options for contacting customer service representatives. Buttons 1228 allow users to shop, change menu displays, view additional settings, and perform other actions. A timer display 1230 can display an amount of time the application has been in use, when the application automatically will log out, or others. A user can select a menu button 1232 to access an options menu for application navigation and information.

FIG. 12C is an example embodiment of WalletFILL sales search screen 1234. As shown in the example embodiment, users can view a list of transactions 1236 meeting search criteria. For each transaction listing 1238, information can be displayed including purchaser name, date of transaction, time of transaction, transaction code, and others. Search field 1240 allows users to enter a date and can display a calendar 1242 so users can select one or more dates. Selected dates sales information 1244 displays a quantity and total sales revenue for the dates selected by the user. Buttons 1246 allow users to navigate the sales search by choosing all orders, selected orders, current orders and others. A back button 1248 allows users to return to a previous screen.

FIG. 12D is an example embodiment of a wallet fill allocation screen 1250. As shown in the example embodiment, an information field 1252 can describe general features. Here, field 1252 states “View daily account balances for all orders that have been placed under your WalletFILL Vault. Your WalletFILL Vault contains all your entities that produce money. Inside your Vault you can assign the WalletFILL Benefactor which is a recipient of the WalletFILL stash. The contents of your Vault and Benefactors account balances are shown below.” WalletFILL allocation field 1254 shows a breakdown of information by stores, names, percentages, benefactors, amounts and other information. A Change Vault button allows users to change a current vault.

FIG. 12E is an example embodiment of a wallet fill sales search information screen 1258. As shown in the example embodiment, users can view a list of transactions 1260 meeting search criteria. For each transaction listing 1262, information can be displayed including purchaser name, date of transaction, time of transaction, transaction code, transaction amount, and others. Search field 1264 allows users to enter a date. Selected dates sales information 1266 displays a quantity and total sales revenue for the dates selected by the user. Buttons 1268 allow users to navigate the sales search by choosing all orders, selected orders, current orders and others.

FIG. 12F is an example embodiment of vault contents option screen 1270. As shown in the example embodiment, if a user selects a change vault button 1256, the system can display different vaults that the user can select to view associated information.

FIG. 12G is an example embodiment screenshot of a WalletFILL Vault screen 1272. As shown in the example embodiment, a total amount is shown as $729.51, which has increased from the $631.11 amount shown in FIG. 12D, due to an order of $98.39 being placed.

In some embodiments, the systems, methods and devices described herein can be implemented, in whole or in part, with software applications such as Quick Manager. As described herein, systems, methods and devices implementing and applying computer logic and algorithms in hardware and software using processors that can execute instructions stored in non-transitory, computer readable memory, that can assist in minimizing human error to vulnerable portions of an order fulfillment process. As would be understood in the art, the principles and concepts described herein ensure that scanned items accurately match those in one or more entity databases. As such, individual entities can utilize unique or universal numbering or other product identification systems as desired or required and therefore is not dependent upon any specific numbering or referencing system.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed. Additionally, all publications discussed herein are hereby incorporated by reference in their entirety.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A computer implemented method for order-fulfillment via a network, comprising:
a network-connected customer device, including a processor and non-transitory computer readable memory storing instructions that, when executed by the processor:
selectively display items to a customer-user via a display of the customer device;
create an order including at least one customer-user selected item; and
selectively transmit the order to a network-connected system server;
the system server, including a processor and non-transitory computer readable memory storing instructions that, when executed by the processor:
compare items from the received order with items in an inventory database;
add the received order to a pending order fulfillment queue for order-fulfillment; and
a network-connected system-user device, including a processor and non-transitory computer readable memory storing instructions that, when executed by the processor:
selectively display items of the order, including location information to a first system-user via a display of the system-user device;
selectively capture an item image using a camera of the system-user device;
compare item details associated with the captured item image to stored item details;
if the compared item details match, update the order accordingly;
wherein, once all items of the order have been gathered by the first system-user, a second system-user can fulfill the order by delivering the gathered items of the order to the customer-user.
